(19) United States
(12) Patent Application Publication
(10) Pub. No.: US 2004/0175599 A1
(43) Pub. Date: Sep. 9, 2004

(54) Fuel cell replenishment using a cartridge

(75) Inventors: Theodore K. Ricks, Rochester, NY (US); Dennis R. Zander, Penfield, NY (US); Eugene Sisto, Rochester, NY (US)

Correspondence Address: Milton S. Sales, Patent Legal Staff, Eastman Kodak Company, 343 State Street, Rochester, NY, 14650-2201, US

(73) Assignee: Eastman Kodak Company

(21) Appl. No.: 10/379,853

(22) Filed: Mar. 5, 2003

(51) Int. Cl. H01M 8/04; H01M 2/36; B65D 88/58

(52) U.S. Cl. 429/15; 429/80

(57) ABSTRACT

A replenisher is used in a system to replenish a fuel cell. The replenisher has a casing that extends around an interior space. The casing has a partition that defines an infeed chamber and an outfeed chamber within the interior space. The partition has an access channel that extends between the infeed and outfeed chambers. The chambers each have a port. The replenisher has a biaser disposed within the casing. The biaser pressurizes the infeed chamber positively and the outfeed chamber negatively.

### FIELD OF THE INVENTION

The invention relates to fuel cells and wet cell batteries and related methods and equipment and more particularly relates to a fuel cell replenishment cartridge and method.

### BACKGROUND OF THE INVENTION

Small fuel cells have been developed that can be used in place of conventional rechargeable and non-rechargeable batteries in portable computers, digital cameras, and other electronic devices. Fuel cells provide electricity by reacting a fuel held within the cell. During use, fuel is depleted. The fuel cell can be renewed by replacing the spent fuel. In some fuel cells, and electrolyte solution is likewise depleted during use and must be replaced for renewal. Many large fuel cells provide continuous replacement during use by continuously pumping in new solutions. This requires much additional equipment and is inconvenient for small fuel cells.

U.S. Patent Application Publication No. 2003/0010115 A1 discloses a fuel cell having an attached external fuel reservoir. This adds greatly to the size of the fuel cell.

U.S. Pat. No. 6,460,733 discloses a flexible or rigid fuel container for fuel cell fuel. The container has a seal that is pieced by a needle to release the fuel for transport to the fuel cell. The fuel drains out through the needle under the force of gravity or pressure provided by a pressure chamber or by use of an external pump.

Some photofinishing equipment uses multiple fluids that are depleted during use. U.S. Pat. No. 5,797,681 discloses processing equipment that can be used with a multiply-chambered container of processing solutions. The processor simultaneously pierces separate seals over each chamber of the container to release the replenishment fluids into the processor.

It would thus be desirable to provide articles and methods that would allow easy and convenient replenishment of one or more solutions of a fuel cell without use of additional equipment.

### SUMMARY OF THE INVENTION

The invention is defined by the claims. The invention, in broader aspects, provides a replenisher is used in a system to replenish a fuel cell. The replenisher has a casing that extends around an interior space. The casing has a partition that defines an infeed chamber and an outfeed chamber within the interior space. The partition has an access channel that extends between the infeed and outfeed chambers. The chambers each have a port. The replenisher has a biaser disposed within the casing. The biaser pressurizes the infeed chamber positively and the outfeed chamber negatively.

It is an advantageous effect of the invention that an improved fuel cell replenisher and method are provided, in which the replenisher can replenish a fuel cell, simply and easily, without use of additional equipment.

### BRIEF DESCRIPTION OF THE DRAWINGS

The above-mentioned and other features and objects of this invention and the manner of attaining them will become more apparent and the invention itself will be better understood by reference to the following description of an embodiment of the invention taken in conjunction with the accompanying figures wherein:

FIG. 1 is a side view of an embodiment of the replenisher.

FIG. 2 is a top perspective view of the replenisher of FIG. 1.

FIG. 3 is a top view of the replenisher of FIG. 1.

FIG. 4 is a rear view of the replenisher of FIG. 1.

FIG. 5 is a cross-sectional view of the replenisher of FIG. 1 taken substantially along line A-A of FIG. 3. The biaser is shown in a fully discharged position.

FIG. 6 is another cross-sectional view of the replenisher of FIG. 1 taken substantially along line B-B of FIG. 4.

FIG. 7 is the same view as FIG. 5, but the biaser is shown in a fully charged position.

FIG. 8 is the same view as FIG. 3, but shows a different section line.

FIG. 9 is still another cross-sectional view of the replenisher of FIG. 1 taken substantially along line C-C of FIG. 8.

FIG. 10 is a diagrammatical top view of another embodiment of the replenisher.

FIG. 11 is a diagrammatical side view of the replenisher of FIG. 10. Arrows indicate direction of displacement of solutions.

FIG. 12 is a diagrammatical side view of an embodiment of the system that includes the replenisher of FIG. 1, before, during, and after replenishment. Arrows indicate directions of displacement of solutions.

FIG. 13 is a diagrammatical side view of another embodiment of the replenisher.

FIG. 14 is a diagrammatical side view of yet another embodiment of the replenisher.

FIG. 15 is a diagrammatical side view of still another embodiment of the replenisher.

### DETAILED DESCRIPTION OF THE INVENTION

The replenisher 10 has a casing 12 that extends around an interior space. The interior space is divided by a partition 14 into at least one pair 16 of chambers. The chamber pair 16 includes an infeed chamber 18 and an outfeed chamber 20. The number of pairs 16 of chambers 18,20 is one or more, depending upon the requirements of a particular fuel cell. Each chamber 18 or 20 of the pair 16 has a port 22 that communicates with the outside environment.

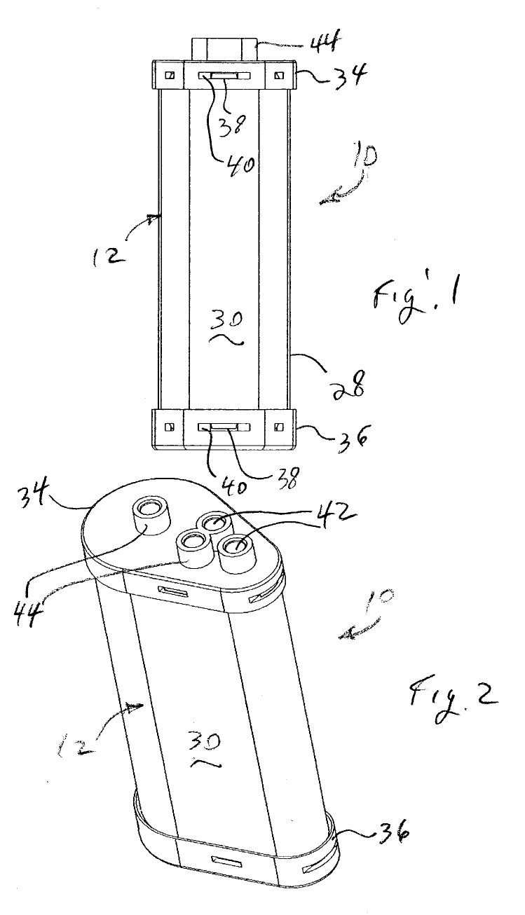

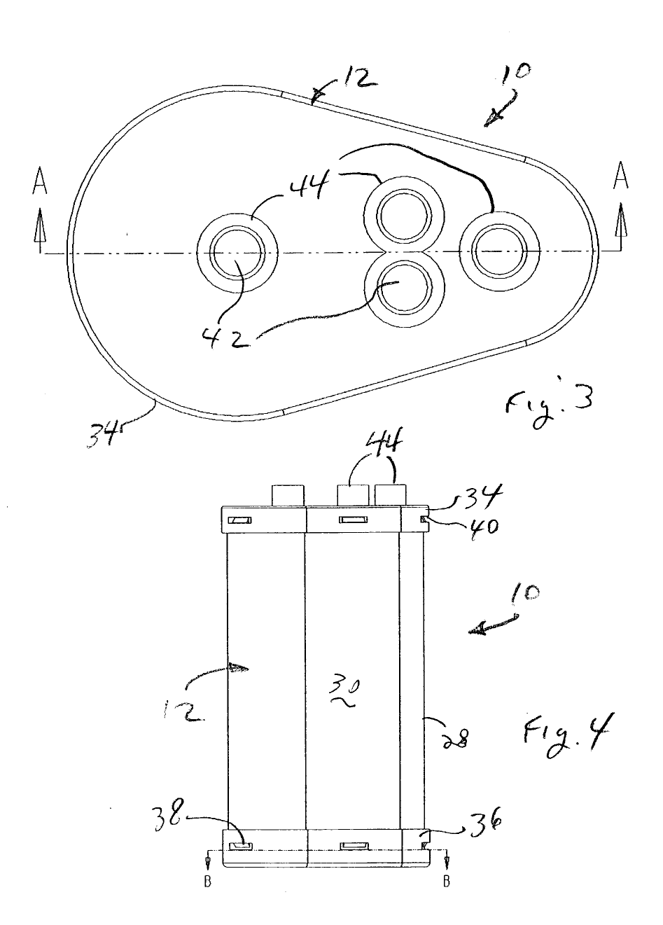

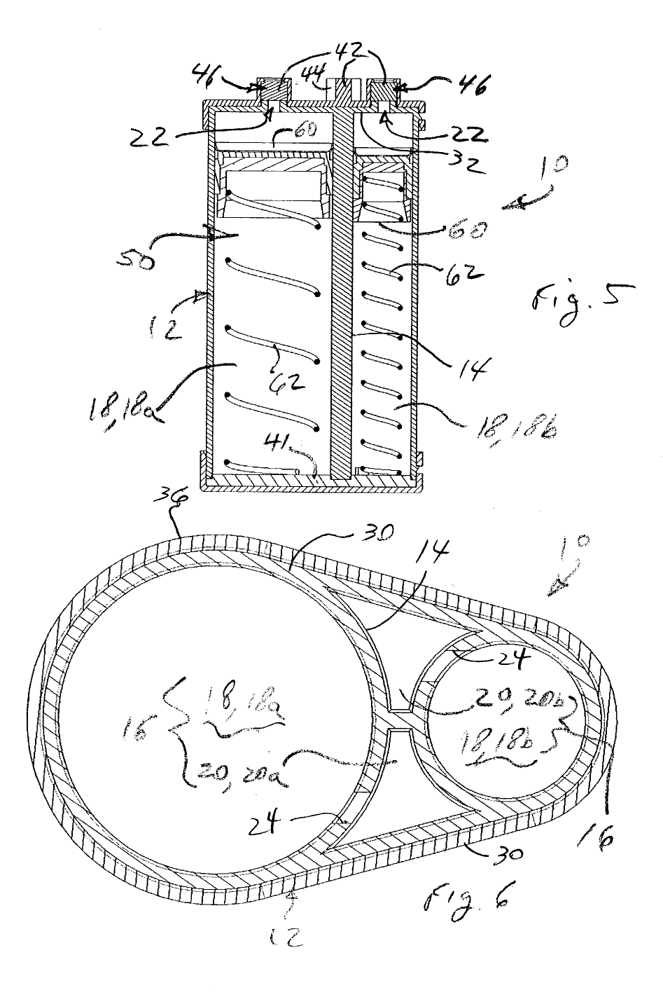

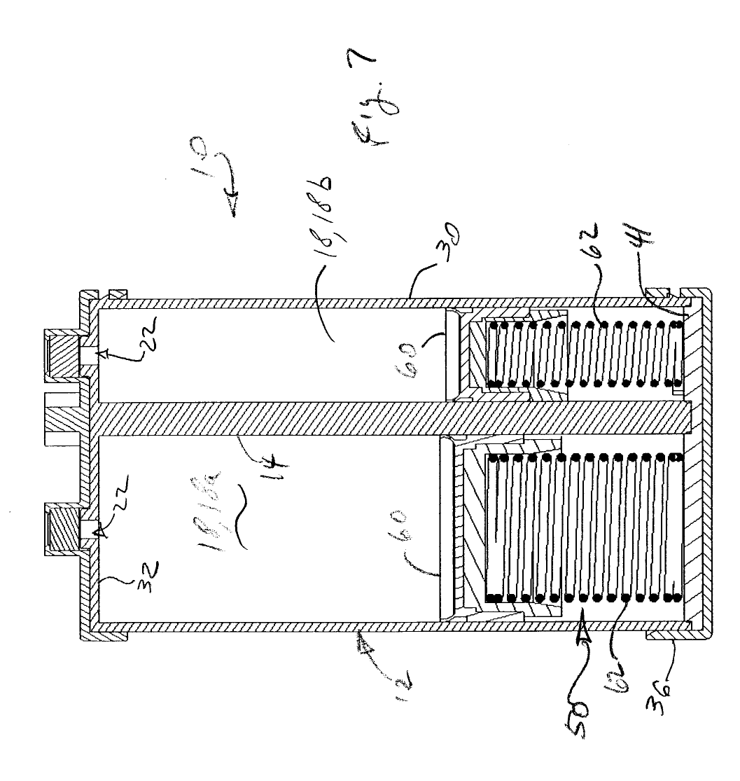

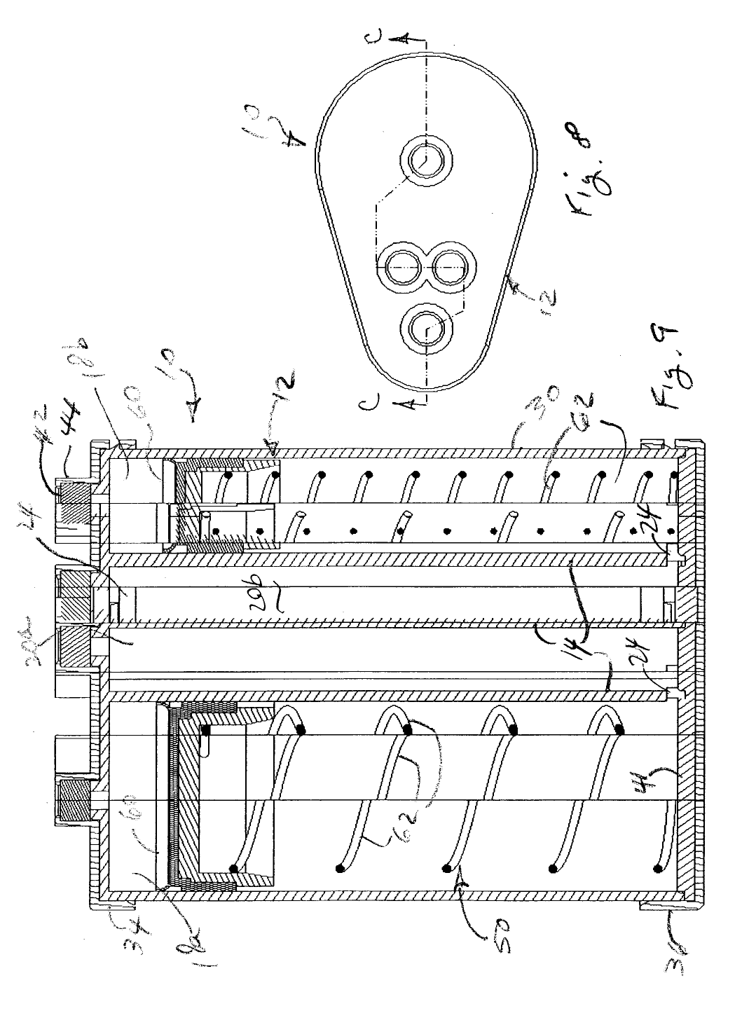

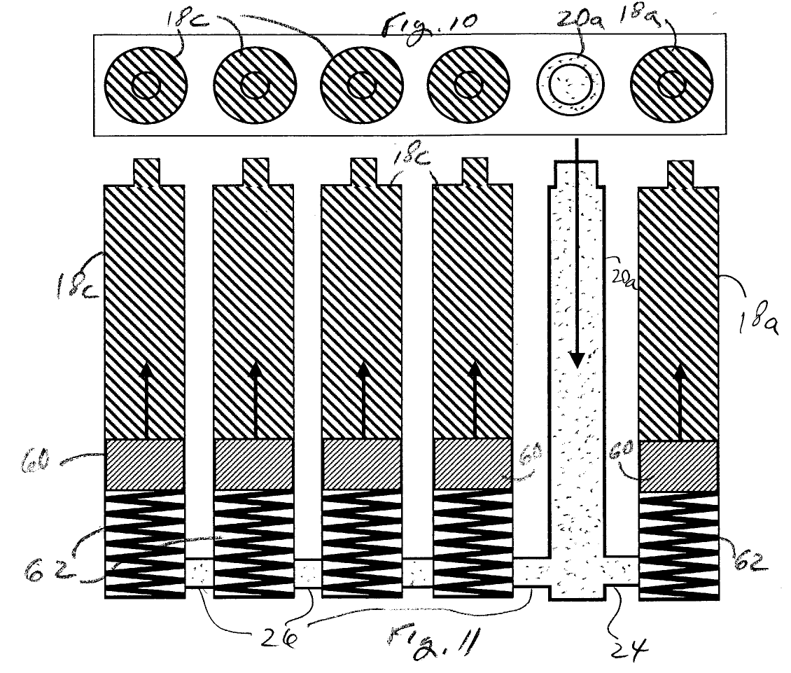

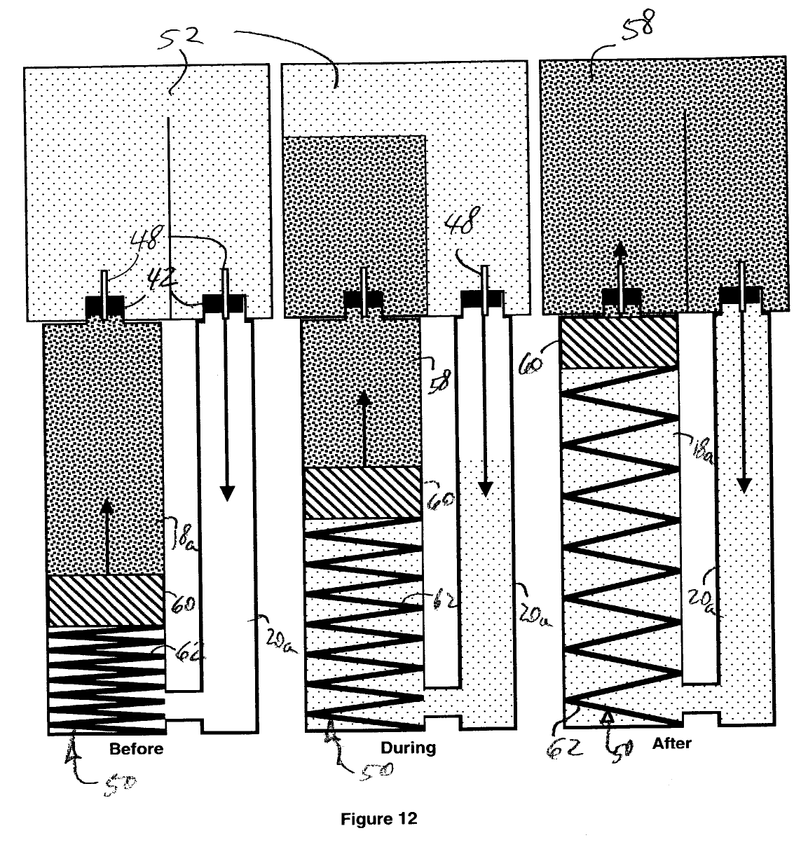

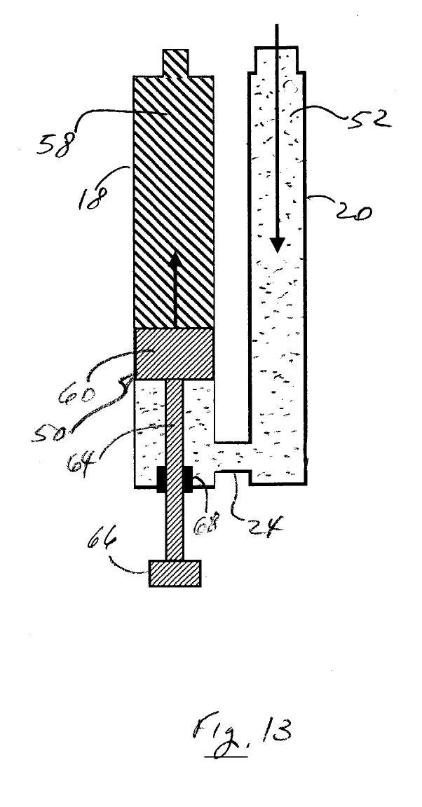

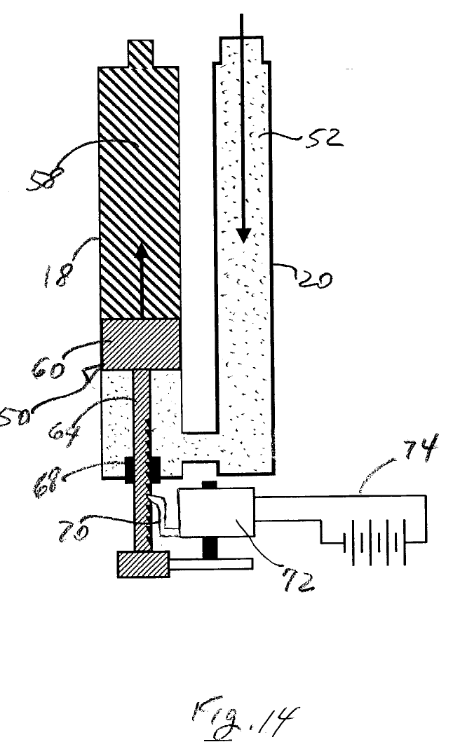

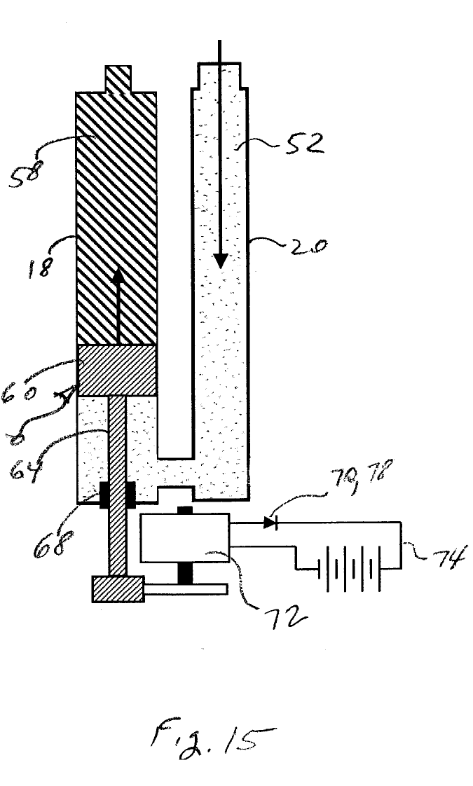

In the embodiment illustrated in FIGS. 1-9, the casing 12 has two pair 16 of chambers 18,20. The first pair 16 includes an infeed fuel chamber 18a and an outfeed fuel chamber 20a. The second pair 16 includes an infeed electrolyte chamber 18b and an outfeed electrolyte chamber 20b. The partition 14 has a first access channel 24 that extends between the infeed and outfeed fuel chambers 18a,20a and a second access channel 24 that extends between the infeed electrolyte and outfeed electrolyte chambers 18b,20b. The partition 14 isolates the fuel chambers 18a,20a from the electrolyte chambers 18b,20b. The invention is generally discussed in terms of this embodiment, but it will be understood that like considerations apply to other embodiments.

The replenisher 10, in the disclosed embodiments, is intended for use with small fuel cells. It is preferred that the chambers have volumes in the range of 1 milliliter to 1 liter. The access channels 24 have a smaller storage volume than respective chambers 18,20.

FIGS. 10-11 are diagrammatical views of the fuel chambers 18a,20a of another embodiment of the replenisher 10. The pair 16 of infeed and outfeed fuel chambers 18a,20a are at the right side of the drawing. The infeed and outfeed chambers 18a,20a are connected by an access channel 24. In this embodiment, in addition to the pair 16 of fuel chambers 18a,20a, four additional infeed fuel chambers 18c are provided within the casing 12. (Electrolyte chambers are not shown. Depending upon the requirements of a particular fuel cell, the replenisher can be limited to fuel chambers. Alternatively, a set of electrolyte chambers having the same arrangement or a different arrangement can be provided.) The additional infeed fuel chambers 18c are connected to the outfeed fuel chamber 20a by auxiliary channels 26 that are positioned in the same manner as the access channel 24. A variety of other arrangements of chambers can be provided. For example, additional outfeed chambers can be provided. Auxiliary channels can provide communication between all chambers of the same type or only between some of the chambers. Alternatively, every pair of chambers can be isolated from other pairs.

Referring again to FIGS. 1-9, the casing 12 has an outer wall 28 that can be provided as a one-piece plastic casting. The outer wall 28 includes a sidewall 30 that has a cylindrical shape with a uniform oval cross-section. This shape is not critical. Other shapes of sidewalls, chambers, and other features can be provided, as desired.

The sidewall 30 has two opposed ends. An end wall 32 closes the upper end. (Directional terms, such as “upper” that are used herein are arbitrary, except in reference to the figures. The replenisher is usable in any absolute orientation.) The end wall 32 is interrupted by the ports 22. The casing 12 can be transparent to permit viewing of the solutions.

The casing 12 has upper and lower end caps 34,36 attached at the upper and lower ends of the sidewall 30. In the embodiment illustrated, the end caps 34,36 are attached to the sidewall 30 by hooks 38 that are formed integrally with the sidewall 30 and fit within slots 40 in the respective caps 34,36. The caps 34,36 can be attached in other manners, such as adhesives, sonic welding, fasteners, and the like. The lower end cap 36 closes the open lower end of the outer wall 28. A seal 41 can be provided to prevent leakage.

Septums 42 close each of the ports 22. The term “septum” is used herein to refer to a self-reclosing seal of the type used on many liquid medical preparations. Such septums can be a uniform piece of elastomer or can have a more complex structure.

The upper end cap 34 has fittings 44 that are aligned with each of the ports 22. The fittings 44 can be configured as required for a particular fuel cell. In the embodiments shown, the fittings 44 are shaped like circular collars that extend outward from the main portion of the upper end cap 34. The fittings 44 each have a central opening (visible in FIG. 5) that is aligned with the respective port 22. The fittings 44 and the end wall 32 together define a series of cavities 46 over the ports 22. A septum 42 is held in each of the cavities 46.

The contents of the chambers 18,20 are accessed by penetrating the respective septums 42 with cannula 48. After access is completed, the cannulas 48 are withdrawn and the septums 42 reseal. Valves that provide a like function, such as check valves can be used in place of or in addition to the septums 42. It is preferred that degassed liquids are used to reduce the risk of bubbling during use.

The replenisher 10 includes a biaser 50 that pressurizes the infeed chamber or chambers 18 positively and the outfeed chamber or chambers 20 negatively. The terms “positively” and “negatively” and like terms, refer to relative rather than absolute pressures.

The biasing causes of fuel cell liquids to flow through the cannula 48 when the septums 42 are penetrated. The cannula can be provided as a part of the fuel cell. Flow of fuel is illustrated in FIG. 12. The movement of depleted fuel 52 is from an internal chamber 54 of a fuel cell 56 into the outfeed fuel chamber 20a and movement of undepleted fuel 58 from the infeed chamber 18 into the chamber 54 of the fuel cell 56. The biaser 50 provides a displacement or pumping action that is sufficient to move the required amounts of the fuel cell solutions.

In the embodiment shown in FIGS. 1-9, the biaser 50 includes a first piston 60 that is located within the infeed fuel chamber 18a and a second piston 60 that is located within the infeed electrolyte chamber 18b. In the embodiment of FIG. 11, the biaser 50 has pistons 60 located in each of the infeed chambers 18. The piston or pistons 60 of the biaser 50 are located between a respective port 22 and the respective access channel 24 or auxiliary channel 26. This provides for positive pressure at the infeed port 22 and negative pressure at the access channel 24 or auxiliary channel 26.

Each of the pistons 60 is driven by a spring 62 that is positioned between the piston 60 and the access channel 24 or auxiliary channel 26 at the lower end of the respective infeed chamber 18. The spring 62 biases the respective piston 60 toward the respective port 22. The spring 62 is loaded or charged when the replenisher 10 is filled with the undepleted solutions, during manufacturing or refilling after earlier use. The solution or solutions are pumped in compressing the respective springs 62. When the cannulas 48 penetrate the septums 42, the seal of the replenisher 10 is broken. This allows displacement of the solutions as the springs 62 act on the pistons 60, impelling the fresh (undepleted) solutions into the fuel cell and dispelling the partially or fully used (depleted) solutions from the fuel cell 56 into the replenisher 10.

Referring now to FIG. 13, in an alternative embodiment, the biaser 50 has a piston 60 that is driven manually. In the case, the piston 60 has a shaft 64 that extends through an opening in the lower end of the infeed chamber 18 to a handle 66. A seal 68 is provided around the shaft 64 to prevent leakage. This approach has the shortcoming that the seal 68 is required and is a potential source of leakage. There is also a risk that the user might draw the piston backwards, during use, causing backflow and undesirable mixing of the depleted and undepleted solutions.

FIG. 14 illustrates another embodiment in which the problem of backward motion of the piston 60 is solved by the provision of an antibackup mechanism 70. The antibackup mechanism 70 illustrated is a ratchet and pawl. In this embodiment, the manual operation is also replaced by a servomotor 72 operated by a power circuit 74 that includes a battery 76.

Another embodiment is illustrated in FIG. 15. In this case, the antibackup mechanism 70 is a diode 78 provided in the power circuit 74 of the motor 72 that the limits the motor 72 to forward operation.

The invention has been described in detail with particular reference to certain preferred embodiments thereof, but it will be understood that variations and modifications can be effected within the spirit and scope of the invention.

What is claimed is:

1. A replenisher:
a casing extending around an interior space, said casing having a partition defining an infeed chamber and an outfeed chamber within said interior space, said partition having an access channel extending between said infeed and outfeed chambers, said chambers each having a port;
a biaser disposed within said casing, said biaser pressurizing said infeed chamber positively and said outfeed chamber negatively.

2. The replenisher of claim 1 wherein said biaser includes a piston disposed in said infeed chamber between a respective said port and said access channel.

3. The replenisher of claim 2 wherein said biaser further comprises a spring biasing said piston toward said port.

4. The replenisher of claim 3 wherein said spring is disposed in said infeed chamber between said access channel and said piston.

5. The replenisher of claim 4 further comprising undepleted fuel cell fuel disposed in said infeed fuel chamber between said piston and said port.

6. The replenisher of claim 4 further comprising depleted fuel cell fuel disposed in said outfeed chamber between said access channel and said piston.

7. The replenisher of claim 1 further comprising a plurality of septums, each said septum sealing a respective said port.

8. A replenisher:
a casing extending around an interior space, said casing having a partition defining a plurality of chamber pairs within said interior space, each said pair having an infeed chamber and an outfeed chamber, said partition having an access channel extending between respective said infeed and outfeed chambers of each said pair, said chambers each having a port;
a biaser disposed within said casing, said biaser pressurizing said infeed chambers positively, and said outfeed chambers negatively.

9. The replenisher of claim 8 wherein said biaser includes a plurality of pistons, each said piston being disposed in a respective said infeed chamber between a respective said port and a respective said access channel.

10. The replenisher of claim 9 wherein said biaser includes a plurality of springs biasing said pistons toward respective said ports.

11. A replenisher:
a casing extending around an interior space, said casing having a partition subdividing said interior space into infeed and outfeed fuel chambers and infeed and outfeed electrolyte chambers, said partition having a first access channel between said infeed and outfeed fuel chambers and a second access channel between said infeed and outfeed electrolyte chambers, said partition isolating said fuel chambers from said electrolyte chambers, said chambers each having a port;
a biaser disposed within said casing, said biaser pressurizing said infeed chambers positively and said outfeed chambers negatively.

12. The replenisher of claim 11 wherein said biaser includes a first piston disposed in said infeed fuel chamber and a second piston and a second piston disposed in said infeed electrolyte chamber, said pistons each being disposed between a respective said port and a respective said access channel.

13. The replenisher of claim 12 further comprising undepleted fuel cell fuel disposed in said infeed fuel chamber between said first piston and the respective said port and undepleted fuel cell electrolyte disposed in said infeed electrolyte chamber between said second piston and the respective said port.

14. The replenisher of claim 12 further comprising depleted fuel cell fuel disposed in said outfeed fuel chamber and in said infeed fuel chamber between said first access channel and said first piston, and depleted fuel cell electrolyte disposed in said outfeed electrolyte chamber and in said infeed electrolyte chamber between said second access channel and said second piston.

15. The replenisher of claim 14 wherein said biaser further comprises a first spring biasing said first piston toward said port of said infeed fuel chamber, and a second spring biasing said second piston toward said port of said infeed electrolyte chamber, said first spring being disposed in said infeed fuel chamber between said first access channel and said first piston, said second spring being disposed in said infeed electrolyte chamber between said second access channel and said second piston.

16. The replenisher of claim 12 wherein said biaser is spring-powered.

17. The replenisher of claim 12 wherein said biaser further comprises a first spring biasing said first piston toward said port of said infeed fuel chamber, and a second spring biasing said second piston toward said port of said infeed electrolyte chamber.

18. The replenisher of claim 11 further comprising a plurality of septums, each said septum sealing a respective said port.

19. The replenisher of claim 18 wherein said casing has a outer wall joined to said partition, said outer wall having opposed first and second ends, said ports extending through said first end, said casing having first and second end caps joined to said outer wall over respective said ends, said septums being held against said first end cap.

20. The replenisher of claim 19 wherein said septums are held between said first end cap and said outer wall.

21. The replenisher of claim 11 further comprising fuel cell fuel disposed in said infeed fuel chamber and fuel cell electrolyte disposed in said infeed electrolyte chamber.

22. A replenisher:
a casing extending around an interior space, said casing having a partition subdividing said interior space into infeed and outfeed fuel chambers and infeed and outfeed electrolyte chambers, said partition having a first access channel between said infeed and outfeed fuel chambers and a second access channel between said infeed and outfeed electrolyte chambers, said partition isolating said fuel chambers from said electrolyte chambers, said chambers each having a port;
a septum covering each of said ports;
a biaser disposed in said infeed chambers, said biaser being operative to generate a positive pressure in said infeed chambers and a negative pressure in said outfeed chambers.

23. A fuel cell replenishment method comprising the steps of:
placing a replenisher against a fuel cell;
during said seating, opening a plurality of fluid paths between said replenisher and said fuel cell;
following said opening, displacing undepleted fuel and undepleted electrolyte from chambers of said replenisher into said fuel cell;
during said impelling, displacing depleted fuel and depleted electrolyte from said fuel cell into said chambers of said replenisher.

24. The method of claim 23 wherein said displacing steps are spring-powered.

25. The method of claim 23 further comprising withdrawing said replenisher from said fuel cell and closing said fluid paths, during said withdrawing.

26. The method of claim 23 wherein said impelling is automatic subsequent to said opening.

27. A fuel cell replenishment system comprising:
a fuel cell including:
a body having first and second chambers;
liquid fuel disposed in said first chamber;
a replenisher including:
a casing extending around an interior space and a partition defining one more pairs of chambers within said interior space, each said pair having an infeed chamber and an outfeed chamber, said partition having on or more access channels, each said channel extending between said infeed and outfeed chambers of each said pair, said chambers each having a port;
a biaser pressurizing said infeed chamber positively and said outfeed chamber negatively.

28. The replenisher of claim 27 wherein said biaser includes one or more pistons, each said piston being disposed in a respective said infeed chamber between a respective said port and a respective said access channel.

29. The replenisher of claim 28 wherein said biaser includes a plurality of springs biasing said pistons toward respective said ports.
